(19) United States
(12) Patent Application Publication
(10) Pub. No.: US 2025/0199880 A1
(43) Pub. Date: Jun. 19, 2025

(54) SYSTEMS AND METHODS FOR OPTIMIZING WORKLOAD DISTRIBUTION TO MINIMIZE ENTITLEMENTS COST

(71) Applicant: Dell Products L.P., Round Rock, TX (US)

(72) Inventors: Ryan N. COMER, Round Rock, TX (US); Anantha K. BOYAPALLE, Cedar Park, TX (US); Marc R. HAMMONS, Round Rock, TX (US)

(73) Assignee: Dell Products L.P., Round Rock, TX (US)

(21) Appl. No.: 18/545,321

(22) Filed: Dec. 19, 2023

(51) Int. Cl. G06F 9/50

(52) U.S. Cl. CPC G06F 9/5083

(57) ABSTRACT

A distributed ecosystem of information handling systems may include a plurality of host systems and a manager comprising a program of instructions configured to, when read and executed by a processor of one of the plurality of host systems: determine workload requirements for a workload to be executed on one of the plurality of host systems; based on endpoint capabilities, current execution load, and a license status for an execution environment of the workload on each of the plurality of host systems, select a selected host system from the plurality of host systems to minimize a number of licenses required for the execution environment; and place the workload for execution on the selected host system.

### TECHNICAL FIELD

The present disclosure relates in general to information handling systems, and more particularly to methods and systems for distribution of workloads across endpoints to minimize entitlements costs.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a distributed computing system, the ecosystem may have a plurality of distributed computing endpoints capable of executing workloads that target different environments. Some of these environments may comprise licensed environments (e.g., Windows) and thus may require a valid license for workloads to be executed in such environment.

In a distributed ecosystem with workload orchestration, workloads that require licensed environments may be placed on different endpoints. For each independent endpoint that a workload is placed on, an additional license key may be required to license the environment on such endpoint for the workload to execute. This may create a problem in existing workload orchestration systems which do not consider the license requirements of environments that workloads execute within. Accordingly, such existing workload orchestration systems may place workloads in a configuration that causes more required licenses than necessary for all concurrent workloads to execute, which may increase licensing costs.

### SUMMARY

In accordance with the teachings of the present disclosure, the disadvantages and problems associated with existing approaches to workload distribution may be reduced or eliminated.

In accordance with embodiments of the present disclosure, a distributed ecosystem of information handling systems may include a plurality of host systems and a manager comprising a program of instructions configured to, when read and executed by a processor of one of the plurality of host systems: determine workload requirements for a workload to be executed on one of the plurality of host systems; based on endpoint capabilities, current execution load, and a license status for an execution environment of the workload on each of the plurality of host systems, select a selected host system from the plurality of host systems to minimize a number of licenses required for the execution environment; and place the workload for execution on the selected host system.

In accordance with these and other embodiments of the present disclosure, a method may include, in a distributed ecosystem of information handling systems comprising a plurality of host systems: determining workload requirements for a workload to be executed on one of the plurality of host systems; based on endpoint capabilities, current execution load, and a license status for an execution environment of the workload on each of the plurality of host systems, selecting a selected host system from the plurality of host systems to minimize a number of licenses required for the execution environment; and placing the workload for execution on the selected host system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in a distributed ecosystem of information handling systems comprising a plurality of host systems: determine workload requirements for a workload to be executed on one of the plurality of host systems; based on endpoint capabilities, current execution load, and a license status for an execution environment of the workload on each of the plurality of host systems, select a selected host system from the plurality of host systems to minimize a number of licenses required for the execution environment; and place the workload for execution on the selected host system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example distributed ecosystem, in accordance with embodiments of the present disclosure;

FIG. 2 illustrates a flow chart of an example method for optimizing distribution of workloads among endpoints in order to minimize entitlements cost, in accordance with embodiments of the present disclosure; and

FIG. 3 illustrates a block diagram of an example optimization of distribution of workloads among endpoints in order to minimize entitlements cost, in accordance with embodiments of the present disclosure.

### DETAILED DESCRIPTION

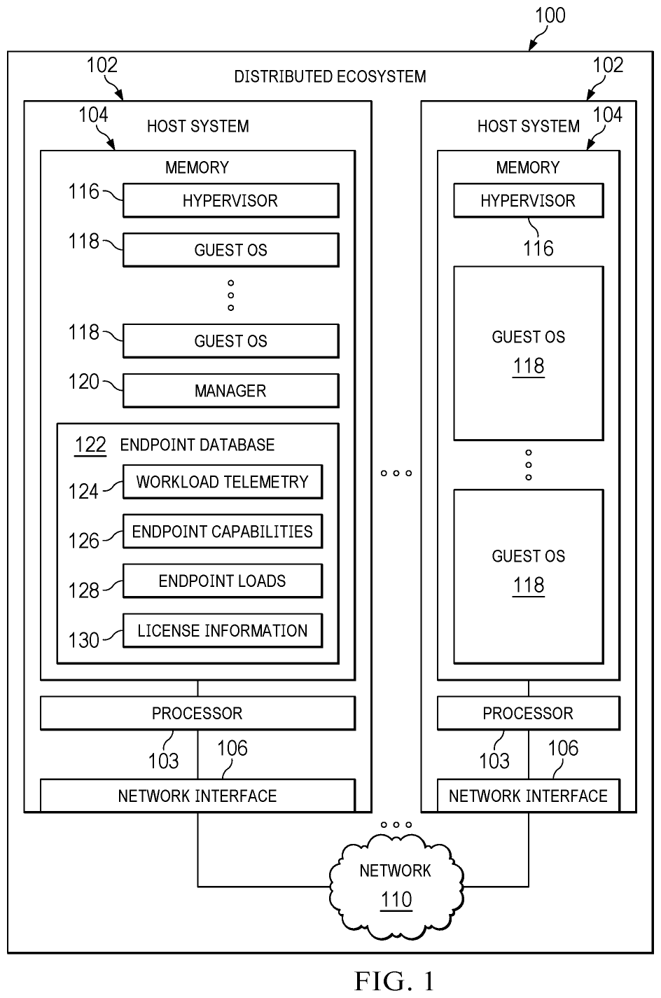

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically distributed ecosystem 100 erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of selected components of an example distributed ecosystem 100 having a plurality of host systems 102, in accordance with embodiments of the present disclosure. As shown in FIG. 1, distributed ecosystem 100 may include a plurality of host systems 102 coupled to one another via a network 110. In some embodiments, two or more of the plurality of host systems 102 may be co-located in the same geographic location (e.g., building or data center). In these and other embodiments, two or more of the plurality of host systems 102 may be co-located in the enclosure, rack, or chassis. In these and other embodiments, two or more of the plurality of host systems 102 may be located in substantially different geographical locations.

A host system 102 may comprise an information handling system. In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, host system 102 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

As used herein, a host system 102 may sometimes be referred to herein as an “endpoint” of distributed ecosystem 100.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to host system 102 is turned off.

As shown in FIG. 1, a memory 104 may have stored thereon a hypervisor 116 and one or more guest operating systems (OS) 118. In some embodiments, hypervisor 116 and one or more of guest OSes 118 may be stored in a computer- readable medium (e.g., a local or remote hard disk drive) other than a memory 104 which is accessible to processor 103.

A hypervisor 116 may comprise software and/or firmware generally operable to allow multiple virtual machines and/or operating systems to run on a single computing system (e.g., a host system 102) at the same time. This operability is generally allowed via virtualization, a technique for hiding the physical characteristics of computing system resources (e.g., physical hardware of the computing system) from the way in which other systems, applications, or end users interact with those resources. A hypervisor 116 may be one of a variety of proprietary and/or commercially available virtualization platforms, including without limitation, VIRTUALLOGIX VLX FOR EMBEDDED SYSTEMS, IBM's Z/VM, XEN, ORACLE VM, VMWARE'S ESX SERVER, L4 MICROKERNEL, TRANGO, MICROSOFT'S HYPER-V, SUN'S LOGICAL DOMAINS, HITACHI'S VIRTAGE, KVM, VMWARE SERVER, VMWARE WORKSTATION, VMWARE FUSION, QEMU, MICROSOFT'S VIRTUAL PC and VIRTUAL SERVER, INNOTEK'S VIRTUALBOX, and SWSOFT's PARALLELS WORKSTATION and PARALLELS DESKTOP.

In one embodiment, a hypervisor 116 may comprise a specially-designed OS with native virtualization capabilities. In another embodiment, a hypervisor 116 may comprise a standard OS with an incorporated virtualization component for performing virtualization.

In another embodiment, a hypervisor 116 may comprise a standard OS running alongside a separate virtualization application. In this embodiment, the virtualization application of the hypervisor 116 may be an application running above the OS and interacting with computing system resources only through the OS. Alternatively, the virtualization application of a hypervisor 116 may, on some levels, interact indirectly with computing system resources via the OS, and, on other levels, interact directly with computing system resources (e.g., similar to the way the OS interacts directly with computing system resources, or as firmware running on computing system resources). As a further alternative, the virtualization application of a hypervisor 116 may, on all levels, interact directly with computing system resources (e.g., similar to the way the OS interacts directly with computing system resources, or as firmware running on computing system resources) without utilizing the OS, although still interacting with the OS to coordinate use of computing system resources.

As stated above, a hypervisor 116 may instantiate one or more virtual machines. A virtual machine may comprise any program of executable instructions, or aggregation of programs of executable instructions, configured to execute a guest OS 118 in order to act through or in connection with a hypervisor 116 to manage and/or control the allocation and usage of hardware resources such as memory, CPU time, disk space, and input and output devices, and provide an interface between such hardware resources and application programs hosted by the guest OS 118. In some embodiments, a guest OS 118 may be a general-purpose OS such as WINDOWS or LINUX, for example. In other embodiments, a guest OS 118 may comprise a specific-and/or limited-purpose OS, configured so as to perform application-specific functionality (e.g., persistent storage).

As used herein, a guest OS 118 or virtual machine may sometimes be referred to herein as an “environment” of distributed ecosystem 100.

At least one host system 102 in system 100 may have stored within its memory 104 a manager 120. A manager 120 may comprise software and/or firmware generally operable to manage individual hypervisors 120 and the guest OSes 118 instantiated on each hypervisor 116, including controlling migration of guest OSes 118 between hypervisors 116.

Further, as described in greater detail below, a manager 120 may be configured to perform workload orchestration to place workloads on particular endpoints and environments in order to optimize entitlements cost.

At least one host system 102 in system 100 may have stored within its memory 104 an endpoint database 122. Endpoint database 122 may include table, list, array, or other suitable data structure including one or more entries, wherein the entries set forth metadata or other information regarding endpoints and environments of distributed ecosystem 100. For example, as shown in FIG. 1, endpoint database 122 may include workload telemetry information 124, endpoint capabilities 126, information regarding endpoint loads 128, and license information 130.

Workload telemetry information 124 may include, for a given workload request, information regarding a workload to be executed. For example, such information may include hardware requirements for the workload (e.g., whether the workload requires a graphical processing unit or other particular hardware) and/or performance requirements for the workload (e.g., a maximum latency or execution time for the workload).

Endpoint capabilities 126 may include, for example, information regarding hardware capabilities for an endpoint (e.g., whether the endpoint comprises a graphical processing unit or other particular hardware) and/or a maximum possible load to be executed upon the endpoint.

Endpoint loads 128 may include, for example, information regarding loads presently executing on an endpoint.

License information 130 may include, for example, information regarding which endpoints have licenses for particular environments, how many licenses are available in a license pool for an environment, and any other suitable licensing/entitlement information.

A network interface 106 may include any suitable system, apparatus, or device operable to serve as an interface between an associated host system 102 and network 110. A network interface 106 may enable its associated host system 102 to communicate with network 110 using any suitable transmission protocol (e.g., TCP/IP) and/or standard (e.g., IEEE 802.11, Wi-Fi). In certain embodiments, a network interface 106 may include a physical network interface controller (NIC). In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable network interface cards, including without limitation, mezzanine cards, network daughter cards, etc.

Network 110 may be a network and/or fabric configured to communicatively couple information handling systems to each other. In certain embodiments, network 110 may include a communication infrastructure, which provides physical connections, and a management layer, which organizes the physical connections of host systems 102 and other devices coupled to network 110. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data using any storage and/or communication protocol, including without limitation, Fibre Channel, Fibre Channel over Ethernet (FCoE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

In addition to processor 103, memory 104, and network interface 106, a host system 102 may include one or more other information handling resources.

In operation, as described in more detail below, manager 120 may be configured to use workload telemetry 124, endpoint capabilities 126, endpoint loads 128, license information 130, and/or other information in order to optimize distribution of workloads among endpoints in order to minimize entitlements/licensing costs.

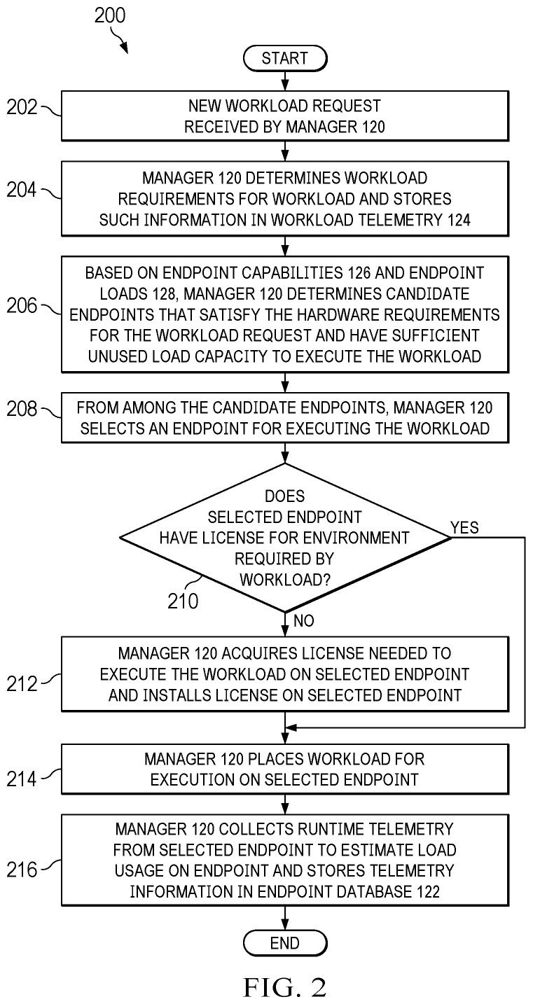

FIG. 2 illustrates a flow chart of an example method 200 for optimizing distribution of workloads among endpoints in order to minimize entitlements cost, in accordance with embodiments of the present disclosure. According to some embodiments, method 200 may begin at step 202 and may be implemented in a variety of configurations of distributed ecosystem 100. As such, the preferred initialization point for method 200 and the order of the steps comprising method 200 may depend on the implementation chosen.

At step 202, a new workload request may be received by manager 120. Such workload request may include a workload manifest that sets forth the hardware, processing, memory, environment, and/or other requirements of the workload. Accordingly, at step 204, manager 120 may determine the workload requirements for the workload and store such information in workload telemetry 124.

At step 206, based on endpoint capabilities 126 and endpoint loads 128, manager 120 may determine candidate endpoints that satisfy the hardware requirements for the workload request and have sufficient unused load capacity to execute the workload. At step 208, manager 120 may, from among the candidate endpoints, select an endpoint for executing the workload (e.g., using a bin-stacking algorithm or other suitable algorithm). In making such selection, manager 120 may give preference to candidate endpoints that are already licensed for the environment required by the workload, for example based on license information 130.

At step 210, manager 120 may determine, for example based on license information 130, whether the selected endpoint has a license for the environment required for the workload. If the selected endpoint has a license for the environment required for the workload, method 200 may proceed to step 214. Otherwise, method 200 may proceed to step 212.

At step 212, manager 120 may acquire from a license pool the license needed to execute the workload on the endpoint and install the license on the endpoint.

At step 214, manager 120 may place the workload for execution on the selected endpoint. At step 216, manager 120 may collect runtime telemetry from the selected endpoint to estimate the load usage on the endpoint, which telemetry information may be stored in endpoint database 122, such that manager 120 may use such information for subsequent determinations of workload distribution among endpoints. After completion of step 216, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using distributed ecosystem 100 or any other system operable to implement method 200. In certain embodiments, method 200 may be implemented partially or fully in software and/or firmware embodied in computer-readable media.

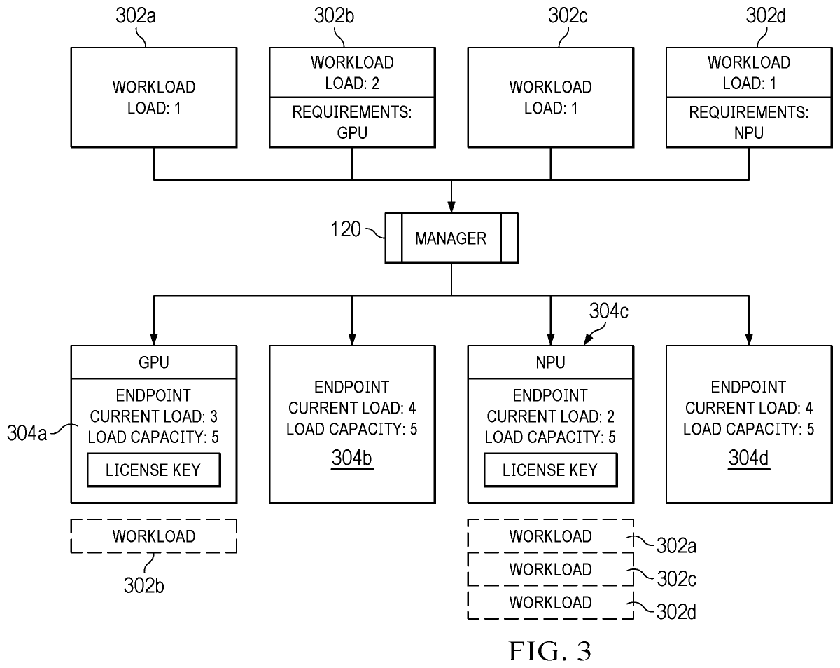

FIG. 3 illustrates a block diagram of an example optimization of distribution of workloads 302 among endpoints 304 in order to minimize entitlements cost, in accordance with embodiments of the present disclosure. Although a distributed ecosystem 100 may execute any suitable number of workloads 302 across any suitable number of endpoints 304, for illustrative purposes, FIG. 3 illustrates distribution of four workloads 302a-302d, all requiring the same licensed environment, across a distributed ecosystem 100 having four endpoints 304a-304d.

As shown in FIG. 3, workload 302a may impose a load of 1 unit, workload 302b may impose a load of 2 units, workload 302c may impose a load of 1 unit, and workload 302d may impose a load of 1 unit. Further, workload 302b may require a graphics processing unit (GPU) while workload 302d may require a neural processing unit (NPU). Endpoint 304a may have a current load of 3 units executing thereon with a load capacity of 5 units and may also include a GPU.

Endpoint 304b may have a current load of 4 units executing thereon with a load capacity of 5. Endpoint 304c may have a current load of 2 units executing thereon with a load capacity of 5 units and may also include an NPU. Endpoint 304d may have a current load of 4 units executing thereon with a load capacity of 5 units. One or both of endpoints 304a and 304c may already have a license for the required environments of workloads 302.

Using the methods and systems disclosed herein, manager 120 may optimize distribution of workloads 302 by placing workload 302b on endpoint 304a to satisfy its requirement for a GPU and by placing workload 302d on endpoint 304c to satisfy its requirement for an NPU. Workloads 302a and 302c are shown as also being placed by manager 120 on endpoint 304c, but such workloads 302a and 302c could also be placed on endpoint 304a.

Using systems and methods similar or identical to those described above, manager 120 may from time to time migrate workloads from one endpoint to another to minimize entitlements cost. For example, in some embodiments, manager 120 may be configured to, from time to time, analyze the workload distribution across endpoints to determine if a more optimal distribution of workloads may be possible. For example, when a workload is finished executing on an endpoint, manager 120 may determine whether distribution may be optimized by migrating remaining workloads on such endpoint to one or more other endpoints, or by migrating workloads from one or more other endpoints to such endpoint.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A distributed ecosystem of information handling systems, comprising:
a plurality of host systems; and
a manager comprising a program of instructions configured to, when read and executed by a processor of one of the plurality of host systems:
determine workload requirements for a workload to be executed on one of the plurality of host systems;
based on endpoint capabilities, current execution load, and a license status for an execution environment of the workload on each of the plurality of host systems, select a selected host system from the plurality of host systems to minimize a number of licenses required for the execution environment; and
place the workload for execution on the selected host system.

2. The information handling system of claim 1, wherein the workload requirements comprise one or more of hardware requirements, processing requirements, memory requirements, and required execution environment for the workload.

3. The information handling system of claim 1, wherein the endpoint capabilities comprise one or more of hardware capabilities, processing capabilities, memory capabilities, and required execution environment for the workload.

4. A method comprising, in a distributed ecosystem of information handling systems comprising a plurality of host systems:
determining workload requirements for a workload to be executed on one of the plurality of host systems;
based on endpoint capabilities, current execution load, and a license status for an execution environment of the workload on each of the plurality of host systems, selecting a selected host system from the plurality of host systems to minimize a number of licenses required for the execution environment; and
placing the workload for execution on the selected host system.

5. The method of claim 4, wherein the workload requirements comprise one or more of hardware requirements, processing requirements, memory requirements, and required execution environment for the workload.

6. The method of claim 4, wherein the endpoint capabilities comprise one or more of hardware capabilities, processing capabilities, memory capabilities, and required execution environment for the workload.

7. An article of manufacture comprising:
a non-transitory computer-readable medium; and
computer-executable instructions carried on the computer-readable medium, the instructions readable by a processor, the instructions, when read and executed, for causing the processor to, in a distributed ecosystem of information handling systems comprising a plurality of host systems:
determine workload requirements for a workload to be executed on one of the plurality of host systems;
based on endpoint capabilities, current execution load, and a license status for an execution environment of the workload on each of the plurality of host systems, select a selected host system from the plurality of host systems to minimize a number of licenses required for the execution environment; and
place the workload for execution on the selected host system.

8. The article of claim 7, wherein the workload requirements comprise one or more of hardware requirements, processing requirements, memory requirements, and required execution environment for the workload.

9. The article of claim 7, wherein the endpoint capabilities comprise one or more of hardware capabilities, processing capabilities, memory capabilities, and required execution environment for the workload.
